(19) United States
(12) Patent Application Publication
(10) Pub. No.: US 2015/0034406 A1
(43) Pub. Date: Feb. 5, 2015

(54) ELECTRIC VEHICLE

(71) Applicant: Kentaro Hirose, Aichi-gun (JP)

(72) Inventor: Kentaro Hirose, Aichi-gun (JP)

(73) Assignee: TOYOTA JIDOSHA KABUSHIKI KAISHA, Toyota-shi, Aichi-ken (JP)

(21) Appl. No.: 14/379,370

(22) PCT Filed: Feb. 23, 2012
(86) PCT No.: PCT/JP2012/054425

§ 371 Date: Aug. 18, 2014

(51) Int. Cl. B60L 3/04; H02J 7/00

(52) U.S. Cl. CPC B60L 3/04; H02J 7/0029
USPC 180/279

(57) ABSTRACT

An electric vehicle is provided, which includes a circuit for discharging a capacitor which smoothes electric current of a power converter. A hybrid vehicle includes a capacitor for smoothing electric current, a discharge circuit, and a discharge controller. The discharge circuit is connected to the capacitor in parallel. The discharge circuit includes a series circuit configured by a first resistor, a PTC thermistor, and a switch. When the discharge controller closes the switch, electric current starts to flow through the first resistor and the PTC thermistor. The capacitor is discharged rapidly. When continuing inflow of electric current to the discharge circuit is more than envisaged, the temperature rises due to heat generation by the PTC thermistor itself, and resistance increases. Thereupon, the electric current flowing into the first resistor is suppressed, suppressing heat generation of the first resistor.

### TECHNICAL FIELD

The present specification relates to an electric vehicle. Specifically, the present specification relates to a technique for discharging a capacitor for smoothing an electric current in a motor power supply system of an electric vehicle. “Electric vehicle” in the present specification includes a vehicle equipped with a fuel cell, and a hybrid vehicle provided with a motor and engine.

### BACKGROUND ART

The rated output of a motor of an electric vehicle is several tens of kilowatts, and a large electric current is required. On the other hand, a motor power supply system is often provided with a capacitor for smoothing pulsations of electric current. Typically, the smoothing capacitor is connected in parallel to an inverter, a voltage converter, etc. A capacitor with a large capacity is utilized for smoothing the large electric current supplied to the motor. Below, the smoothing capacitor will be referred to simply as capacitor. Further, in the present specification, a device for converting electric current or voltage, such as the inverter, voltage converter, etc., will be referred to as “power converter”.

It is not desirable for a large amount of charge to remain in the capacitor after a main switch (ignition switch) of the vehicle has been turned OFF, or in an unexpected event, such as an accident, etc. Therefore, it is desirable for a resistor (discharge resistor) for discharging the capacitor to be provided in the electric vehicle. There are two types of discharge circuit, a type in which a discharge resistor is constantly connected to the capacitor, and a type in which the discharge resistor is connected to the capacitor in particular cases. The former type is exemplified in Patent Documents 1 and 2, and the latter type is exemplified in Patent Documents 3 and 4. Particular cases for connecting the discharge resistor to the capacitor are e.g., a case of the vehicle having collided (Patent Document 3), a case of the main switch of the vehicle having been turned OFF (Patent Document 4), or a case of an interlock provided in a cover of the inverter having been activated (Patent Document 4).

It is preferred that the discharge of the capacitor is completed in a short time. When a small discharge resistor is utilized, the discharge resistor generates heat. However, providing a large discharge resistor is not desirable from the point of view of cost and compactness. Therefore, techniques have been proposed for both rapid discharge of the capacitor and for suppressing heat generation of the discharge resistor.

For example, Patent Document 1 discloses a technique, in an electric vehicle of the type in which a discharge resistor is constantly connected to a capacitor for smoothing an electric current of a power converter (inverter), for reducing loss caused by the heat generation of the discharge resistor. The electric vehicle disclosed in Patent Document 1 utilizes a PTC thermistor (Positive Temperature Coefficient Thermistor) in the discharge resistor. The PTC thermistor is a device whose resistance value increases as temperature increases. In the electric vehicle of Patent Document 1, the temperature of the discharge resistor (PTC thermistor) increases when the inverter operates, the resistance value of the discharge resistor increases, and the electric current flowing into the discharge resistor decreases. Since the electric current flowing into the discharge resistor becomes smaller, loss also becomes smaller. If the inverter is stopped, the temperature of the discharge resistor decreases, and the resistance value thereof also decreases. The electric current that can flow into the discharge resistor from the capacitor increases, and the capacitor is discharged rapidly.

Further, e.g., an electric vehicle is also disclosed in Patent Document 2 in which electric current flowing through a discharge resistor is suppressed when a temperature of a power converter (inverter) increases. Moreover, the electric vehicle of Patent Document 2 is also of the type in which a discharge resistor is constantly connected to a capacitor for smoothing electric current of the inverter. The technique of Patent Document 2 is as follows. In the electric vehicle of Patent Document 2, the discharge resistor and a semiconductor switch are connected in series. The semiconductor switch is an emitter follower transistor, in which electric current flowing through the semiconductor switch decreases when a base voltage increases, and electric current flowing through the semiconductor switch increases when the base voltage decreases. A base electrode is connected to connection points of two resistors that are connected in series. The resistor at a low voltage side is a PTC thermistor, and is disposed in the vicinity of the inverter. While the temperature of the inverter is low, the temperature of the PTC thermistor is also low, and the resistance value thereof is also low. in that case, the base voltage becomes low, more electric current flows through the semiconductor switch, and electric current flows through the discharge resistor. That is, the discharge of the capacitor is accelerated. When the temperature of the inverter rises, the temperature of the PTC thermistor also rises, and resistance value of the PTC thermistor increases. Thereupon, the base voltage rises, and the electric current flowing through the semiconductor switch is reduced. Consequently, the electric current flowing through the discharge resistor is reduced, and the heat generation of the discharge resistor is suppressed. The technique of Patent Document 2 suppresses the heat generation of the discharge resistor when the temperature of the inverter is high. The technique of Patent Document 2 prevents the inverter and the discharge resistor from both generating heat simultaneously.

Further, the electric vehicle disclosed in Patent Document 4 is the type in which the discharge resistor connects to the capacitor upon collision of the vehicle, and includes a temperature sensor for measuring the temperature of the discharge resistor. When the temperature of the discharge resistor reaches a predetermined upper limit, the discharge resistor disconnects from the capacitor, causing another discharge device to operate.

### CITATION LIST

### Patent Literatures

Patent Document 1: Japanese Patent Application Publication No. 2006-042498
Patent Document 2: Japanese Patent Application Publication No. 2008-206313
Patent Document 3: Japanese Patent Application Publication No. 2006-224772
Patent Document 4: Japanese Patent Application Publication No. 2011-234507

### SUMMARY OF INVENTION

The technique of Patent Document 1 utilizes a PTC thermistor as a discharge resistor. The technique of Patent Document 2 utilizes a PTC thermistor as a device for adjusting electric current flowing through a discharge resistor in accordance with the temperature of a power converter. The present specification provides a technique which uses a PTC thermistor more effectively, efficiently discharging a capacitor while suppressing heat generation of a discharge resistor.

One aspect of the technique taught in the present specification provides an electric vehicle comprising a discharge circuit and a discharge controller. The discharge circuit is a device for discharging a smoothing capacitor connected in parallel to an input end or output end of a power converter connected between a battery and a motor. The electric vehicle taught in the present specification is a type in which the discharge resistor is connected to the smoothing capacitor in particular cases (e.g., collision), and rapidly discharges the capacitor.

The discharge circuit of the present specification is connected to the capacitor in parallel. The discharge circuit includes a series circuit (series connection) which is configured by a first resistor, a PTC thermistor and a switch, in other words, the series circuit configured by the first resistor, the PTC thermistor, and the switch is connected to the capacitor in parallel. The first resistor mainly corresponds to a discharge resistor. The switch is normally open. The discharge controller closes the switch if a predetermined discharge condition is satisfied, and discharges the capacitor. The predetermined discharge condition is, e.g., detecting collision of the vehicle, detecting a communication abnormality, detecting that output voltage of an auxiliary battery is at a predetermined threshold voltage or less, a main switch of the vehicle having been turned OFF, detecting other particular abnormalities, etc.

In the discharge circuit, when the discharge controller closes the switch, electric current starts to flow through the first resistor and the PTC thermistor connected in series. Since initially the temperature of the PTC thermistor is low, a large amount of electric current flows through the discharge resistor (first resistor), and the capacitor is discharged rapidly. If the inflow of electric current to the discharge circuit continues more than envisaged, temperature rises due to the heat generation by the PTC thermistor itself, and resistance increases. Thereupon, since combined resistance value of the first resistor and the PTC thermistor is increasing, the electric current flowing to the discharge resistor is suppressed. The heat generation of the first resistor is suppressed.

In the electric vehicle taught in the present specification, the discharge resistor connects to the capacitor when the above discharge condition is satisfied. When the discharge condition is satisfied, the electric vehicle usually disconnects a main battery, and cuts off power supply from other than the capacitor. Therefore, electric current flows through the discharge circuit only from the capacitor, and the discharging of the capacitor is completed. However, in case of a collision, electric current may flow to the discharge circuit from other than the capacitor. In one case, it may not be possible to disconnect the battery due to a malfunction. In another case, the motor may be idling, and generating power. In the former case, electric current flows from the battery to the discharge circuit, and in the latter case, the electric current generated by the motor flows to the discharge circuit via the inverter. In preparation for such a case, the discharge circuit preferably not only suppresses the electric current flowing to the first resistor by means of the PTC thermistor, but can also continue discharging over a comparatively long time. Therefore, an improved discharge circuit taught in the present specification preferably comprises a second resistor, as described below.

The second resistor may be connected to the first resistor and the switch in series, and may be connected to the PTC thermistor in parallel. Resistance value of the second resistor may be typically selected such that its default value is smaller than a maximum resistance value of the PTC thermistor, and larger than a resistance value at the Curie temperature. In this discharge circuit, while the temperature of the PTC thermistor is low, a larger amount of electric current flows through the PTC thermistor than through the second resistor. The capacitor is discharged rapidly via the first resistor and the PTC thermistor. When the temperature of the PTC thermistor increases, and the resistance value of the PTC thermistor becomes greater than the resistance value of the second resistor, the amount of electric current flowing through the second resistor becomes greater than the amount of electric current flowing through the PTC thermistor. When the temperature of the PTC thermistor becomes high, i.e., the resistance value becomes high, the series circuit configured by the first resistor and the second resistor becomes dominant with respect to discharging. That is in this discharge circuit, while the temperature of the PTC thermistor is low, a series circuit configured by the first resistor and the PTC thermistor becomes the total discharge resistor, and when the temperature of the PTC thermistor becomes high, a series circuit configured by the first resistor and the second resistor becomes the total discharge resistor. A direct connection of the first resistor and the PTC thermistor will be called a first type of discharge resistor, and the series circuit configured by the first resistor and the second resistor will be called a second type of discharge resistor. The first type of discharge resistor is capable of rapidly discharging the capacitor. By appropriately selecting the resistance value of the second resistor, a discharge resistor can be configured in which discharge capacity is not as high as that of the first type of discharge resistor, but which can stably continue discharging over a long time. In the case where electric current flows to the discharge circuit from other than the capacitor, the discharge circuit described above can automatically switch the characteristics of the discharge resistor, and can stably continue discharging over a long time.

Further, the discharge controller is preferably programmed to open the switch after a predetermined time has passed since the switch was closed. By opening the switch, the discharge circuit can be protected from overheating.

The discharge circuit preferably further comprises a third resistor connected in parallel to the series circuit which is configured by the first resistor, the PTC thermistor, and the switch, the third resistor having a resistance value larger than a combined resistance value of the first resistor and the second resistor. Alternatively, in case of not having the second resistor, the discharge circuit preferably further comprises a fourth resistor connected in parallel to the series circuit which is configured by the first resistor, the PTC thermistor, and the switch, the fourth resistor having a resistance value larger than a resistance value of the first resistor. The third resistor or the fourth resistor may be constantly connected to the capacitor. The third resistor or the fourth resistor does not have a high discharge capacity, but may assist the discharging of the capacitor. For example, the capacitor can be discharged slowly even in a case where the switch is opened but discharging is not performed by the first resistor and the second resistor.

It would be ideal to utilize a large capacity discharge resistor which generates a small amount of heat even if excessive electric current is flowing, but the size and cost of the discharge resistor would increase. The technique taught in the present specification can, as one advantage, suppress the size and cost of the discharge resistor.

Details of the technique taught in the present specification and further improvements thereto will be described in the embodiment of the invention.

### BRIEF DESCRIPTION OF DRAWINGS

FIG. 1 is a block diagram of a power system of an electric vehicle of a first embodiment.

FIG. 2 is a flowchart diagram of a discharge process.

FIG. 3 is a graph showing of a characteristics PCT thermistor.

FIG. 4 is a block diagram of a power system of an electric vehicle of a second embodiment.

FIG. 5 is a block diagram of a power system of an electric vehicle of a third embodiment.

FIG. 6 is a block diagram of a power system of an electric vehicle of a fourth embodiment.

### DESCRIPTION OF EMBODIMENTS

### First Embodiment

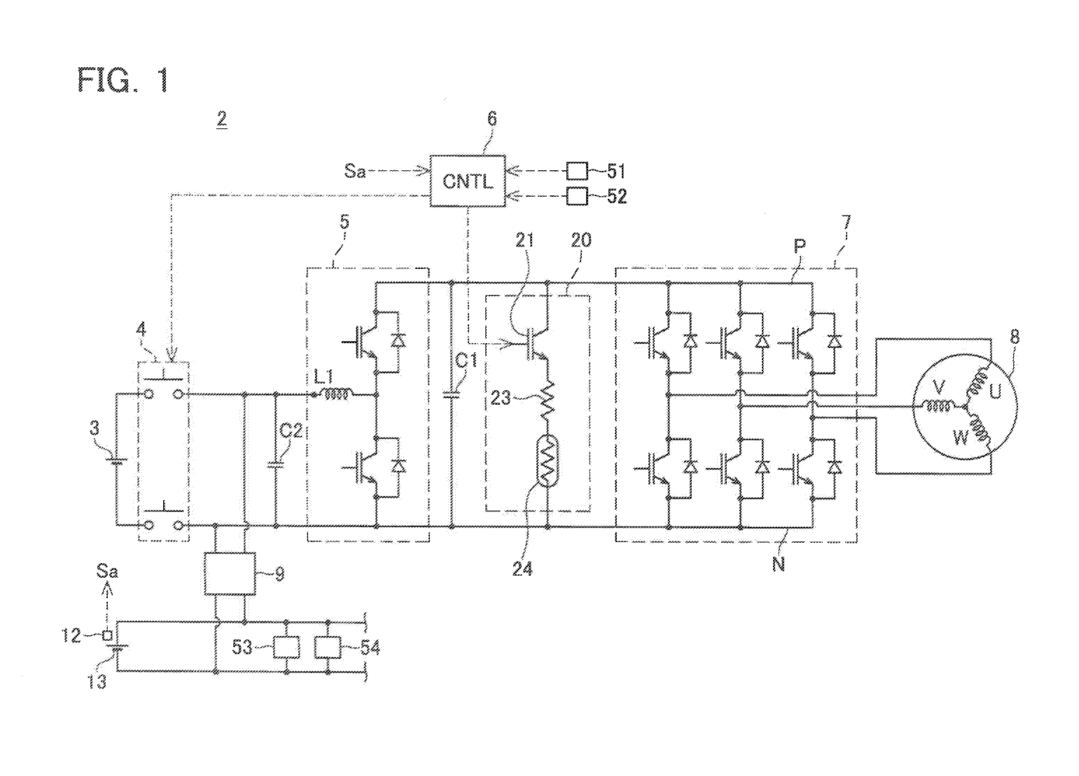

An electric vehicle of a first embodiment will be described. The electric vehicle of the first embodiment is a hybrid vehicle 2 comprising both an engine and a motor for driving, FIG. 1 shows a block diagram of a power system of the hybrid vehicle 2. In FIG. 1, the engine is not shown. Further, it should be noted that only components needed for the description of the present specification are depicted in FIG. 1, and devices not related to the description are not shown even if the devices belong to the power system.

Power for driving a motor 8 is supplied from a main battery 3. The output voltage of the main battery 3 is, e.g., 300 volts. Moreover, in addition to the main battery 3, the hybrid vehicle 2 also comprises an auxiliary battery 13 for supplying power to devices (often called “auxiliaries”) such as a car navigation system 53, an interior light 54, etc., which are driven by a voltage lower than the output voltage of the main battery 3. The output voltage of the auxiliary battery 13 is, e.g., 12 volts or 24 volts.

The main battery 3 is connected to a voltage converter 5 via a system main relay 4. The system main relay 4 is a switch to connect or disconnect the main battery 3 and the power system of the vehicle. The system main relay 4 is switched by a controller 6.

The voltage converter 5 boosts the voltage of the main battery 3 to a voltage suitable for driving a motor (e.g., 600 volts). An inverter 7 is connected to a high voltage side (the right side of FIG. 1) of the voltage converter 5. As is well known, the inverter 7 is a circuit for converting DC power into AC power having a desired frequency. The power of the main battery 3 is boosted by the voltage converter 5, is further converted by the inverter 7 into AC power suitable for driving the motor, and is supplied to a motor 8. Further, the hybrid vehicle 2 may drive the motor utilizing deceleration energy of the vehicle from the time of braking, and generate power. The power generated by the motor 8 is converted to DC by the inverter 7, and is further decreased by the voltage converter 5 to a voltage suitable for charging the main battery 3.

As shown in FIG. 1, the voltage converter 5 is constituted by two switching circuits and a reactor L1. Moreover, the switching circuits are constituted by a transistor, which is a switching element, and an anti-parallel circuit which is a freewheeling diode. One end of the reactor L1 is connected to the main battery 3 via the system main relay 4, and the other end of the reactor L1 is connected to a midpoint of the two switching circuits. As is well known, the voltage converter 5 of FIG. 1 can boost voltage input from the left side of the figure and output the voltage to the right side, and can step down voltage input from the right side of the figure and output the voltage to the left side. The voltage converter 5 can boost the voltage of the main battery 3 and supply the voltage to the inverter 7, and can step down the power generated by the motor 8, and supply the power to the main battery 3. The latter operation is called regeneration, Since the configuration of the inverter 7 is well known, a description thereof is omitted.

The output of the main battery 3 is also connected to a step-down converter 9. The step-down converter 9 is a device for reducing the voltage of the main battery 3 to a driving voltage for the auxiliaries (the car navigation system 53, the interior light 54, etc.). The output of the step-down converter 9 is connected to an auxiliary power line. The auxiliary battery 13 described above is also connected to the auxiliary power line. While the system main relay 4 is closed, the main battery 3 supplies power to the auxiliaries via the step-down converter 9. Simultaneously, the auxiliary battery 13 is charged by the power of the main battery 3. The auxiliary battery 13 supplies power to the auxiliaries while the system main relay 4 is open.

A capacitor C2 is connected to a low voltage side (i.e., main battery side) of the voltage converter 5, and a capacitor C1 is connected to a high voltage side of the voltage converter 5. Both the capacitors C1, C2 are connected to the voltage converter 5 in parallel. The capacitor C2 is inserted in order to smooth the electric current output by the main battery 3, and the capacitor C1 is inserted in order to smooth the electric current input to the inverter 7. Moreover, high potential side wires of the switching elements of the inverter 7 are referred to as a P line, and ground potential side wires wire thereof are referred to as an N line. The capacitor C1 is inserted between the P line and the N line. Since a large electric current is supplied to the motor 8 from the main battery 3, the capacitor C1 and the capacitor C2 both have a large capacity. While the power system is activated, a large capacity charge is charged in the capacitors C1 and C2. Therefore, it is desirable for the capacitors C1 and C2 to rapidly discharge when the power system has stopped, or when an accident such as a collision, etc. has occurred. The hybrid vehicle 2 comprises a discharge circuit 20 for discharging the capacitors C1 and C2. Next, the discharge circuit 20 will be described.

The discharge circuit 20 is a circuit connected to the capacitor C1 in parallel. In other words, the discharge circuit 20 is connected between the high potential line (P line) and the ground potential line (N line) of the power system. The discharge circuit 20 is constituted by a series circuit (series connection) configured by a semiconductor switch 21, a first resistor 23, and a PTC thermistor 24. As described above, the PTC thermistor 24 is an element whose resistance value increases as temperature rises. The semiconductor switch 21 is opened and closed by the controller 6. The controller 6 controls various devices. However, since the following description centers upon control of the discharge circuit 20, the controller 6 will be called the “discharge controller 6” below.

The semiconductor switch 21 is normally open while the power system is activated. That is, the first resistor 23 and the PTC thermistor 24 are normally disconnected from the capacitor C1. When a predetermined condition is satisfied, the discharge controller 6 closes the semiconductor switch 21, and connects the first resistor 23 and the PTC thermistor 24 to the capacitor C1. When the first resistor 23 and the PTC thermistor 24 have been connected to the capacitor C1, the charge of the capacitor C1 flows through the first resistor 23 and the PTC thermistor 24, and the capacitor C1 is discharged. Moreover, since the capacitor C2 is also connected via the voltage converter 5, the capacitor C2 is also discharged by the discharge circuit 20. In the following description only the capacitor C1 is cited, but it should be noted that the same applies to the capacitor C2.

The predetermined conditions for closing the semiconductor switch 21 are typically the following conditions. (1) In case of a collision of the vehicle. The hybrid vehicle 2 comprises an air bag 51 with a built-in acceleration sensor. In case acceleration detected by the acceleration sensor exceeds a predetermined threshold, a controller of the air bag 51 sends a signal to the discharge controller 6 indicating that the vehicle has collided. Upon receiving the signal indicating that the vehicle has collided, the discharge controller 6 closes the semiconductor switch 21.

(2) In case a main switch (ignition switch) of the vehicle has been turned OFF. A signal from a main switch 52 is sent to the discharge controller 6. In the case where the main switch 52 has been turned OFF, the discharge controller 6 closes the semiconductor switch 21.

(3) In case a remaining amount (SOC: State Of Charge) of the auxiliary battery 13 is at a predetermined SOC threshold or less. The hybrid vehicle 2 comprises a SOC sensor 12 for measuring the SOC of the auxiliary battery 13. An output signal Sa of the SOC sensor 12 is sent to the discharge controller 6. The output signal Sa indicates the SOC of the auxiliary battery 13. In case, based on the output signal Sa of the SOC sensor 12, the remaining amount of the auxiliary battery 13 is at the SOC threshold or less, the discharge controller 6 closes the semiconductor switch 21.

(4) In case an abnormality occurs in communication with other controllers. In case communication with another controller (e.g., the air bag controller) is interrupted, the discharge controller 6 closes the semiconductor switch 21. A plurality of controllers which accord with various functions is provided for one vehicle. The plurality of controllers communicates with one another. In order to notify another controller of being in a state capable of performing communication, each of the controllers sends a predetermined signal at regular intervals. Such a signal is generally called a keep-alive signal. The keep-alive signal is not restricted to motor vehicles, but is a technique also utilized by, e.g., network computers, etc. The vehicle of the embodiment may also utilize a keep-alive signal. In the motor vehicle of the embodiment, the discharge controller 6 determines that a communication abnormality has occurred in case of not receiving a keep-alive signal after a predetermined time period, and the discharge controller 6 closes the semiconductor switch 21.

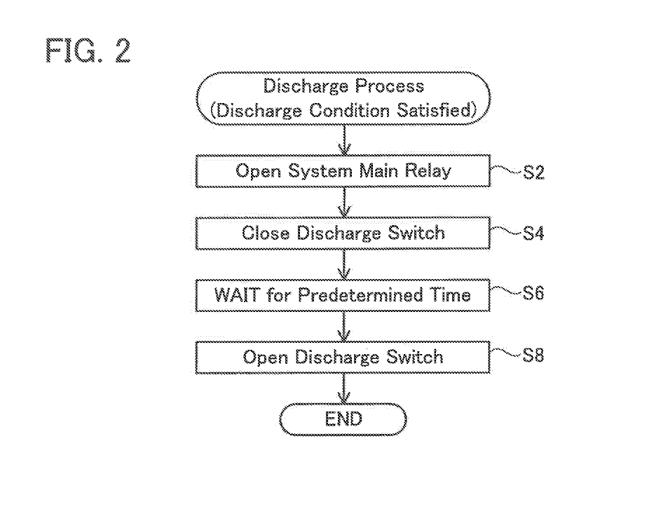

If any of the above four conditions is satisfied, the discharge controller 6 closes the semiconductor switch 21, and connects the first resistor 23 and the PTC thermistor 24 to the capacitor C1. Consequently, the capacitor C1 is discharged. Electrical energy stored in the capacitor C1 becomes heat emitted by the first resistor 23 and the PTC thermistor 24, and is dissipated. The four conditions described above correspond to discharge conditions. FIG. 2 shows a flowchart of processes executed by the discharge controller 6 when a discharge condition is satisfied. In case the discharge condition is satisfied, the discharge controller 6 opens the system main relay 4 prior to closing the semiconductor switch 21 (S2). This is to disconnect the main battery 3 from the capacitor C1 and the discharge circuit 20, cutting off the continual supply of power to the discharge circuit 20. Next, the discharge controller 6 closes the semiconductor switch 21 (discharge switch) (S4). The discharge controller 6 opens the semiconductor switch 21 after having waited for a predetermined time (S6, S8). The predetermined time is set to be a time in which it is expected that the capacitance of the capacitor C1 can be discharged. The predetermined time is, e.g., between 5 seconds to 60 seconds.

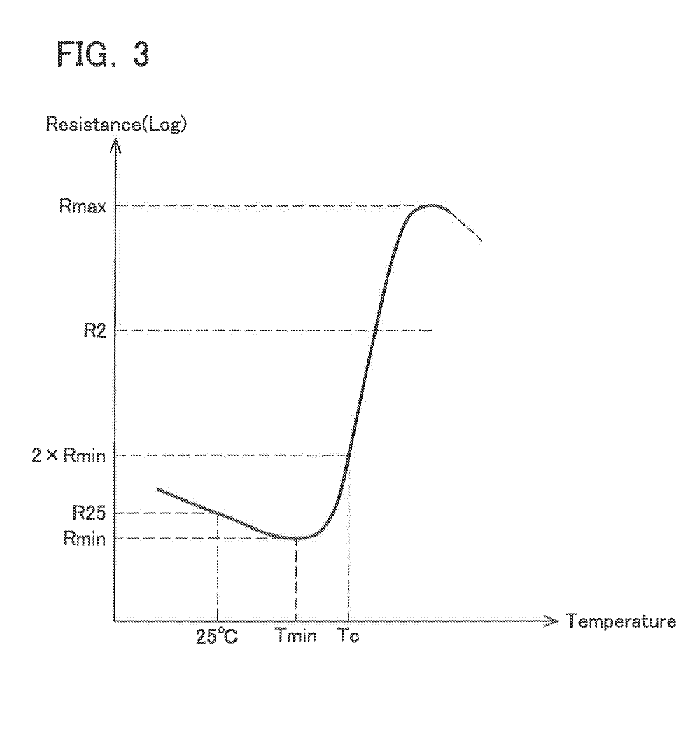

The first resistor 23 and the PTC thermistor 24 are connected in series. The role of the PTC thermistor 24 will be described. “PTC” is an abbreviation of Positive Temperature Coefficient. The PTC thermistor is an element having the characteristic that, as temperature increases, resistance value also increases. Typical characteristics of the PTC thermistor are shown in FIG. 3. The vertical axis of FIG. 3 represents resistance value, and the horizontal axis represents temperature. FIG. 3 is a schematic graph, but it should be noted that a logarithmic axis is utilized on the vertical axis, In the PTC thermistor, resistance value increases rapidly in a region higher than a Curie temperature Tc. The Curie temperature Tc is a temperature corresponding to the resistance value that is twice the minimum resistance value Rmin.

In the discharge circuit 20, when the semiconductor switch 21 is closed, electric current starts to flow through the first resistor 23 and the PTC thermistor 24 which are connected in series. Since the temperature of the PTC thermistor 24 is initially low, a large amount of electric current flows through the first resistor 23, and the capacitor C1 is discharged rapidly. If there is a power supply source other than the capacitor C1 (and C2), and inflow of electric current to the discharge circuit 20 continues more than envisaged, the temperature of the PTC thermistor 24 rises due to the heat generated by the heat PTC thermistor 24 itself, and resistance value rapidly increases. Thereupon, the electric current flowing into the series circuit of the first resistor 23 and the PTC thermistor 24 is greatly reduced. Consequently, the heat generation by the first resistor 23 is suppressed. Specific characteristics of the first resistor 23 and the PTC thermistor 24 are selected so as to finish discharging of the capacitor C1 while the temperature of the PTC thermistor 24 is the Curie temperature or less.

It is usually the case that connection to the capacitor C1 of the first resistor 23 of the discharge circuit 20 occurs when the vehicle is stopped, and the system main relay 4 is open (see step S2 of FIG. 2). Therefore, normally, when the semiconductor switch 21 of the discharge circuit 20 is closed (i.e., when the first resistor 23 is connected to the capacitor C1), there are no devices other than the capacitor C1 (and C2) supplying electric current to the first resistor 23. However, in particular circumstances, a device other than the capacitor C1 (and C2) may be present that is supplying electric current to the first resistor 23. In particular, when the vehicle has caused an accident, electric current may flow, as described below, into the discharge circuit 20 from a device other than the capacitor C1 (and C2).

In a case where the vehicle collides and damage to a drive system occurs, the motor 8 may continue to rotate and to generate power. Typically, this is a case where a drive shaft or gearbox connecting the motor 8 and wheels have been damaged. Further, in case any upper arm (an upper side switching element in FIG. 1) of the inverter 7 remains closed, the electric current generated by the motor 8 flows into the discharge circuit 20. Alternatively, in case the system main relay 4 malfunctions, and the system main relay 4 remains closed, the electric current from the main battery 3 flows into the discharge circuit 20. For example, in case a contact of the system main relay 4 has been welded, the system main relay 4 remains closed regardless of a command from the discharge controller 6 (see step S2 of FIG. 2). In the above circumstances, there is the possibility of electric current flowing into the discharge circuit 20 for a longer time than expected. In such a case, the electric current flowing through the first resistor 23 is restricted by the PTC thermistor 24, protecting the first resistor 23. Further, in case (3) or (4) above are selected as the condition for dosing the semiconductor switch 21, there is the possibility of condition (3) or (4) occurring at a time other than a collision, and consequently there is the possibility that the vehicle will continue to run even though the semiconductor switch 21 has been dosed, and that the electric current generated by the motor 8 will flow into the discharge circuit 20.

In case electric current flows into the discharge circuit 20 from a device other than the capacitor C1 (and C2), it is preferred that discharging is continued even if discharging cannot be performed as quickly as by the series circuit configured by the first resistor 23 and the PTC thermistor 24. Therefore, a technique will be described next for improving the first embodiment so as to continue discharging by another route when the resistance value of the PTC thermistor 24 has increased.

### Second Embodiment

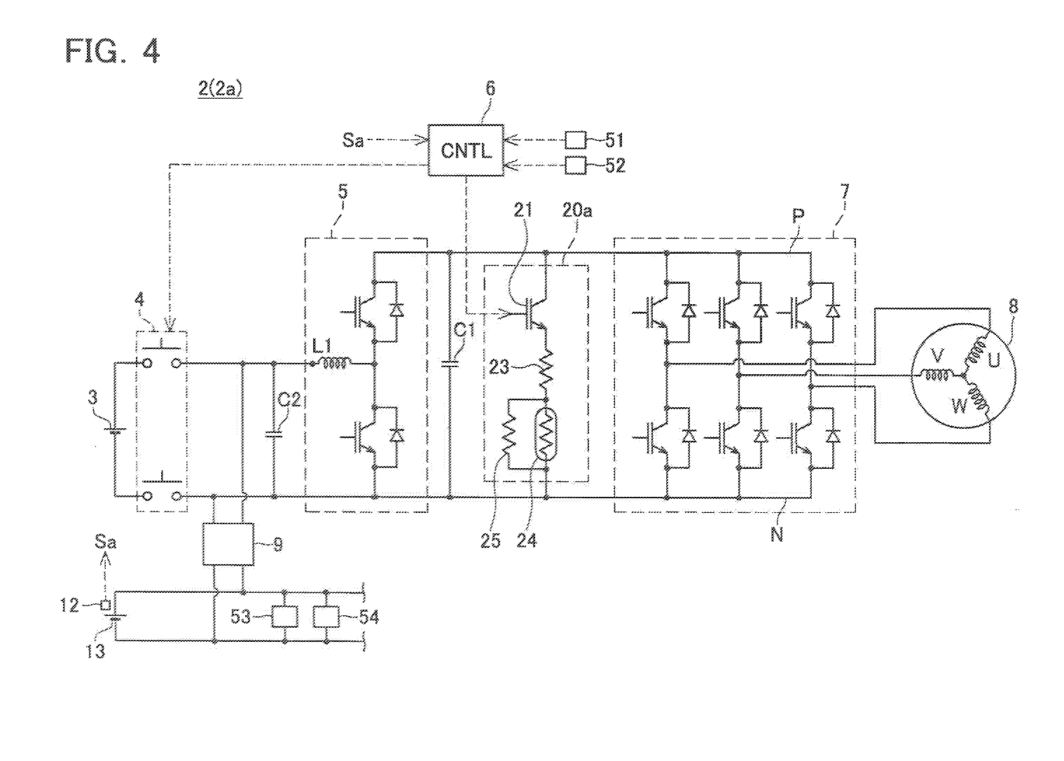

FIG. 4 shows a block diagram of a hybrid vehicle 2a of a second embodiment. In the hybrid vehicle 2a, the configuration of a discharge circuit 20a differs from the first embodiment. The configuration other than the discharge circuit 20a is the same as the first embodiment, and consequently a description thereof is omitted.

The discharge circuit 20a comprises a second resistor 25 in addition to the configuration of the discharge circuit 20 of the first embodiment. The second resistor 25 is connected to the semiconductor switch 21 and the first resistor 23 in series. Further, the second resistor 25 is connected to the PTC thermistor 24 in parallel. According to this configuration, electric current flows through the series circuit configured by the first resistor 23 and the PTC thermistor 24 while the temperature of the PTC thermistor 24 is low. When the temperature of the PTC thermistor 24 increases, the electric current flows through the series circuit configured by the first resistor 23 and the second resistor 25. That is, the path along which the electric current flows is switched according to the temperature of the PTC thermistor 24. By appropriately selecting the resistance value of the second resistor 25, a second electric current path (the first resistor 23+the second resistor 25) can be configured in which discharge efficiency is lower than the electric current path at low temperatures (the first resistor 23+the PTC thermistor 24), but which is capable of a certain degree of discharging. The resistance value of the second resistor 25 is preferably equal to or higher than the resistance value of the first resistor 23. In a case where the resistance value of the second resistor 25 is the same as that of the first resistor 23, total resistance at high temperatures (the first resistor 23+the second resistor 25) becomes approximately twice a total resistance value at low temperatures (the first resistor 23+the PTC thermistor 24). Consequently, the amount of heat generated becomes approximately half, and discharge efficiency also becomes approximately half. According to the configuration of FIG. 4, in case a larger amount of electric current than expected flows into the discharge circuit 20a, the discharge circuit can be protected, and discharging can be continued. Moreover, the resistance value of the second resistor 25 is selected to be a value higher than resistance value (2×Rmin) at the Curie temperature Tc of the PTC thermistor 24. As a typical example, a resistance value R2 of the second resistor 25 is an intermediate value between a maximum resistance value Rmax of the PTC thermistor 24, and the resistance value (2×Rmin) at the Curie temperature (see FIG. 3).

In case of the second embodiment, as in the first embodiment, the discharge controller 6 may perform the processes of the flowchart of FIG. 2, That is, the discharge controller 6 may be programmed to open the semiconductor switch 21 when the discharge condition is satisfied, and after a predetermined time has passed since when the semiconductor switch 21 was closed. According to this configuration, discharging of the first resistor 23 and the second resistor 25 that are connected to the semiconductor switch 21 in series can be prevented, and the heat generation by these resistors can be suppressed, preventing damage. Further, since the discharge circuit 20a of the second embodiment comprises the second resistor 25 for preventing overheating of the first resistor 23, discharging for a long time can also be withstood. Therefore, after the discharge condition has been satisfied, the discharge controller 6 may keep the semiconductor switch 21 closed until being reset.

### Third Embodiment

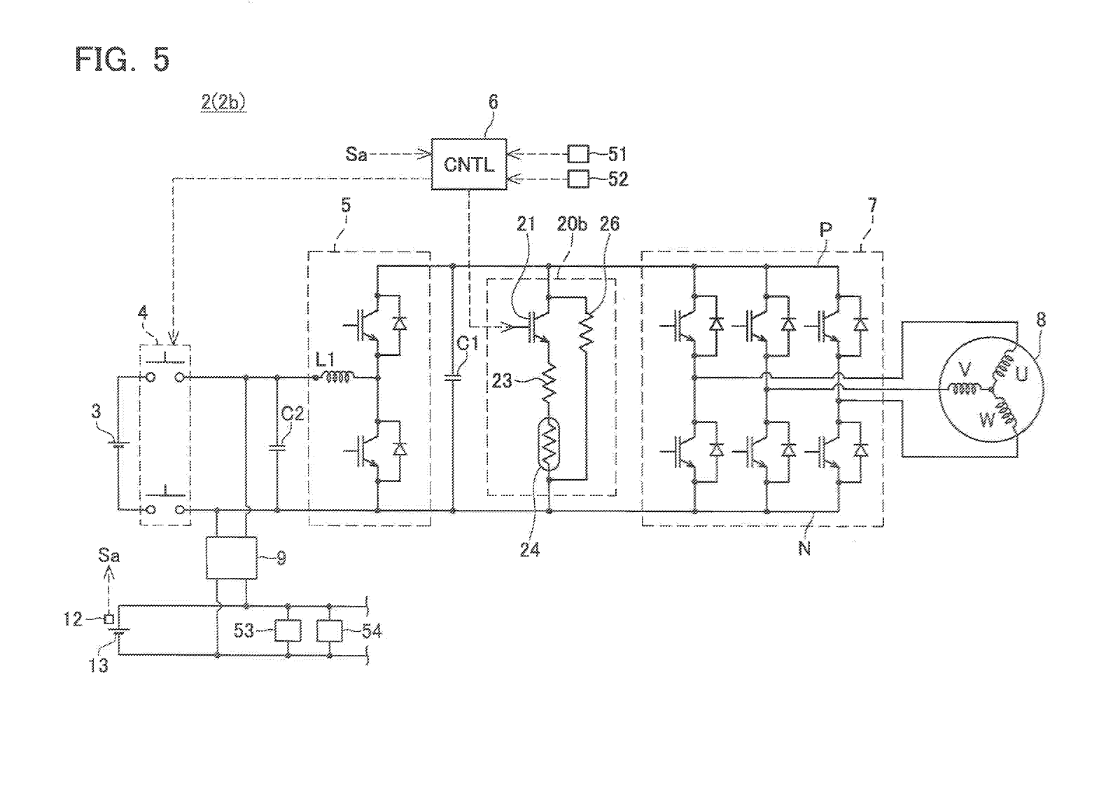

Next, an electric vehicle of a third embodiment will be described. FIG. 5 shows a block diagram of a hybrid vehicle 2b of a third embodiment. In the hybrid vehicle 2b, the configuration of a. discharge circuit 20b differs from the first embodiment. The configuration other than the discharge circuit 20b is the same as the first embodiment, and consequently a description thereof is omitted. The discharge circuit 20b comprises a third resistor 26 in addition to the configuration of the discharge circuit 20 of the first embodiment, The third resistor 26 is connected in parallel to a series circuit which is configured by the semiconductor switch 21, the first resistor 23 and the PTC thermistor 24. That is, the third resistor 26 is constantly connected to the capacitor C1 in parallel. The resistance value of the third resistor 26 is selected to be a value higher than the resistance value of the first resistor 23. The discharge circuit 20b of the third embodiment discharges the capacitor C1 slowly even while the semiconductor switch 21 is open. With this configuration, in case the semiconductor switch 21 is not closed due to an accident, the capacitor C1 can be discharged, even if this discharge is slow. Alternatively, in case a charge remains in the capacitor C1 after a specified time has passed since opening the semiconductor switch 21 in the flowchart of FIG. 2, the discharge circuit 20b can discharge the remaining charge.

### Fourth Embodiment

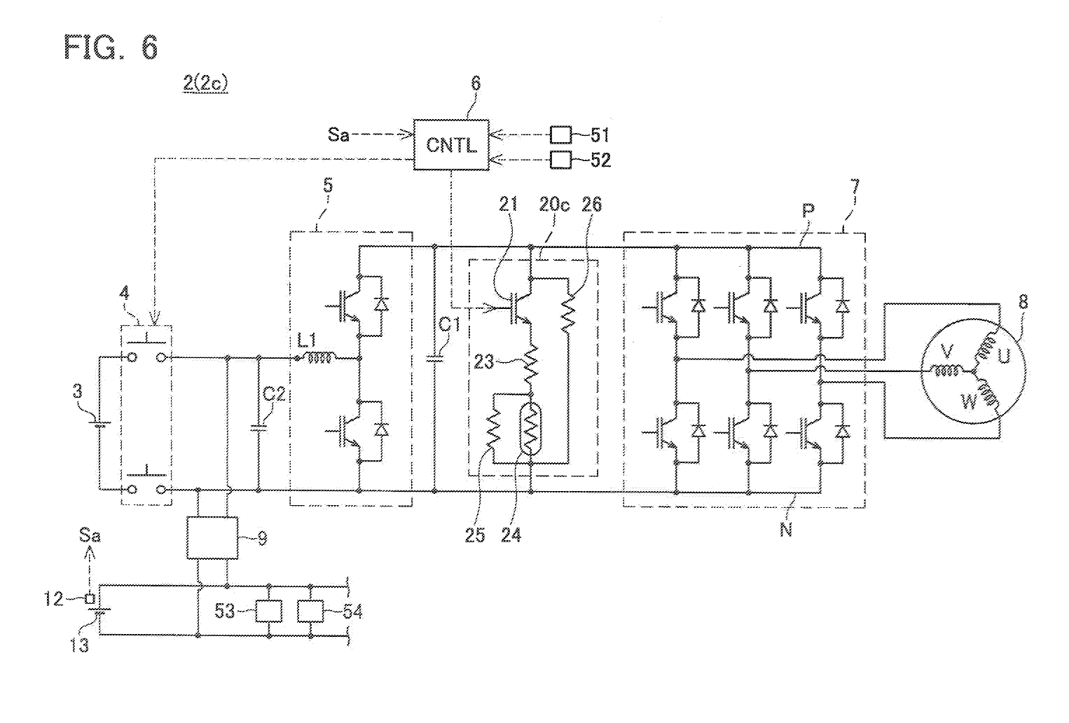

Next, an electric vehicle of a fourth embodiment will be described, FIG. 6 shows a block diagram of a hybrid vehicle 2c of the fourth embodiment. In the hybrid vehicle 2c, the configuration of a discharge circuit 20c differs from the first embodiment. The configuration other than the discharge circuit 20c is the same as the first embodiment, and consequently a description thereof is omitted. The discharge circuit 20c comprises both the second resistor 25 of the second embodiment and the third resistor 26 of the third embodiment. Consequently, the hybrid vehicle 20 of the fourth embodiment comprises both the advantages of the hybrid vehicle 2a of the second embodiment and the advantages of the hybrid vehicle 2b of the third embodiment.

Considerations relating to the embodiments will be described. The vehicle of the embodiments comprises the main battery 3, the power converter, the main relay (the system main relay 4) and the capacitor C1. The main battery 3 is provided in order to store power for the motor. The power converter is connected between the main battery 3 and the motor 8. The power converter is typically a device for converting the power from the main battery 3 into power suitable for driving the motor, and is the inverter 7 or the voltage converter 5. The main relay (the system main relay 4) is a switch to connect or disconnect the connection of the main battery 3 and the power converter. The capacitor is connected in parallel to an input end or output end of the power converter, and smoothes the electric current.

The vehicle of the embodiments further comprises a discharge circuit for discharging the capacitor. The discharge circuit is connected to the capacitor in parallel. A discharge circuit (the discharge circuit 20) of one aspect of the technique taught in the present specification comprises a series circuit configured by the first resistor 23, a PTC thermistor (the PTC thermistor 24), and a switch (the semiconductor switch 21).

A discharge circuit (the discharge circuit 20a) of another aspect taught in the present specification comprises the second resistor 25 which is connected to the first resistor 23 and the switch in series, and is connected to the PTC thermistor in parallel. By providing the second resistor 25, the discharge circuit 20a automatically switches the electric current path when the temperature of the PTC thermistor is low and when the temperature of the PTC thermistor is high. The electric current path when the temperature is low is the series circuit configured by the first resistor 23 and the PTC thermistor 24, and this circuit can rapidly discharge the capacitor C1. The electric current path when the temperature is high is the series circuit configured by the first resistor 23 and the second resistor 25, and this circuit can discharge the capacitor C1 over a medium term. The first resistor 23 and the second resistor 25 are selected so that the combined resistance of the series circuit configured thereby is greater than the combined resistance of the series circuit configured by the first resistor 23 and the PTC thermistor 24 (here, the resistance value when the temperature of the PTC thermistor 24 is low). Here, “when the temperature is low” means a case of being lower than the Curie temperature of the PTC thermistor 24.

Furthermore, it is desirable for the resistance value of the second resistor 25 to be equal to or more than the resistance value of the first resistor 23. In a case where the resistance value of the second resistor 25 is the same as that of the first resistor 23, the combined resistance of the first resistor 23 and the second resistor 25 (ignoring the resistance value of the PTC thermistor) becomes twice the resistance value of the first resistor alone. That is, the discharge resistance when the PTC thermistor is in an OFF state becomes twice the discharge resistance when the PTC thermistor is in an ON state, and the amount of heat generated by discharge resistance is suppressed to about half.

A discharge circuit (the discharge circuit 20b) of another aspect taught in the present specification further comprises the third resistor 25 which is connected in parallel to the series circuit configured by the first resistor 23, a PTC thermistor (the PTC thermistor 24), and a switch (the semiconductor switch 21), the third resistor 25 having a resistance value larger than the resistance value of the first resistor 23. The third resistor 25 is constantly connected to the capacitor regardless of the state of the switch. Therefore, the discharge circuit 20b can discharge the capacitor C1 over a long term. Moreover, the third resistor 25 in the embodiments corresponds to the “fourth resistor” in the claims.

A discharge circuit (the discharge circuit 20c) of another aspect taught in the present specification comprises, in addition to the configuration of the discharge resistor 20a, the third resistor 25 which is connected in parallel to the series circuit configured by the first resistor 23, a PTC thermistor (the PTC thermistor 24), and a switch (the semiconductor switch 21), and which has a resistance value larger than the combined resistance value of the first resistor 24 and the second resistor 25, This aspect provides the advantages of both the discharge circuit 20a and the discharge circuit 20b.

The vehicle of the embodiments was a hybrid vehicle. The technique taught in the present specification is also suitable for application to a pure electric vehicle not comprising an engine. Further, the technique taught in the present specification is also suitable for application to a fuel cell vehicle.

Representative, non-limiting examples of the present invention have been described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electric vehicle.

Moreover, combinations of features and steps disclosed in the above detail description may not be necessary to practice the invention in the broadest sense, and are instead taught merely to particularly describe representative examples of the invention. Furthermore, various features of the above-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Specific examples of the present invention has been described in detail, however, these are mere exemplary indications and thus do not limit the scope of the claims. The art described in the claims include modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

1. An electric vehicle comprising:
a capacitor configured to smooth an electric current;
a discharge circuit connected to the capacitor in parallel, the discharge circuit including a series circuit which is configured by a first resistor, a PTC thermistor, and a switch; and
a discharge controller configured to close the switch if a predetermined discharge condition is satisfied.

2. The electric vehicle according to claim 1, wherein the discharge condition includes one of: detecting a collision of the vehicle, detecting a communication abnormality, or detecting that an output voltage of an auxiliary battery is at a predetermined threshold voltage or less.

3. The electric vehicle according to claim 1, wherein
the discharge circuit further comprises a second resistor connected to the first resistor and the switch in series, and connected to the PTC thermistor in parallel.

4. The electric vehicle according to claim 3, wherein the discharge controller opens the switch after a predetermined time has passed since when the switch was closed.

5. The electric vehicle according to claim 4, wherein the discharge circuit further comprises a third resistor connected in parallel to the series circuit which is configured by the first resistor, the PTC thermistor, and the switch, the third resistor having a resistance value larger than a combined resistance value of the first resistor and the second resistor.

6. The electric vehicle according to claim 1, wherein the discharge circuit further comprises a fourth resistor connected in parallel to the series circuit which is configured by the first resistor, the PTC thermistor, and the switch, the fourth resistor having a resistance value larger than a resistance value of the first resistor.

7. The electric vehicle according to claim 2, wherein
the discharge circuit further comprises a second resistor connected to the first resistor and the switch in series, and connected to the PTC thermistor in parallel.

8. The electric vehicle according to claim 7, wherein the discharge controller opens the switch after a predetermined time has passed since when the switch was closed.

9. The electric vehicle according to claim 8, wherein the discharge circuit further comprises a third resistor connected in parallel to the series circuit which is configured by the first resistor, the PTC thermistor, and the switch, the third resistor having a resistance value larger than a combined resistance value of the first resistor and the second resistor.
